(19) United States
(12) Patent Application Publication
(10) Pub. No.: US 2008/0051960 A1
(43) Pub. Date: Feb. 28, 2008

(54) Method of Stabilizing a Vehicle in the Event of a Loss of Tire Pressure

(75) Inventor: Guenther SOKOLL, Olching (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/842,547

(22) Filed: Aug. 21, 2007

(30) Foreign Application Priority Data
Aug. 22, 2006 (DE) 10 2006 039 379.1

(51) Int. Cl. G06F 19/00

(52) U.S. Cl. 701/41

(57) ABSTRACT

A method of stabilizing a vehicle in the event of a loss of tire pressure is provided. A driving-stability-related system, which can be manually activated and/or deactivated, is automatically activated when a loss of tire pressure is determined or when the tire pressure is below a defined threshold. The driving-stability-related system preferably remains deactivated when it was manually deactivated again after an automatic activation, at least for a given ignition-cycle.

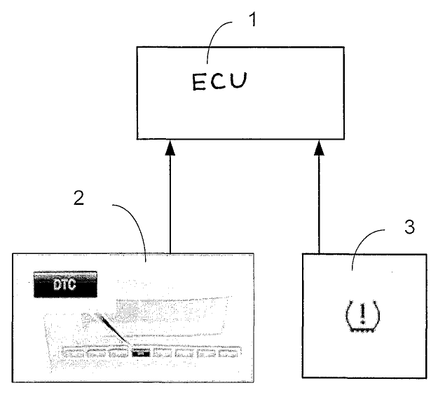

### BACKGROUND AND SUMMARY OF THE INVENTION

This application claims the priority of German Application No. 10 2006 039 379.1, filed Aug. 22, 2006, the disclosure of which is expressly incorporated by reference herein.

The invention relates to a method of stabilizing a vehicle in the event of a loss of tire pressure.

A method of this type is known, for example, from German Patent document DE 102 30 967 A1. Here, a system relating to driving stability takes the momentary tire pressure into account during a special cornering control.

It is an object of the invention to provide another simple method of stabilizing a vehicle in the event of a loss of tire pressure.

According to the invention, the method stabilizes a vehicle in the event of a loss of tire pressure, in that a driving-stability-related system, which manually can be at least deactivated, is automatically activated in the manually deactivated state when a loss of tire pressure is determined or when the tire pressure is below a defined threshold. Advantageous further developments of the invention are described herein.

In the case of a method of stabilizing a vehicle in the event of a loss of tire pressure, a driving-stability-related system, which can be manually activated and/or deactivated, is automatically activated in the manually deactivated state when a loss of tire pressure is determined or when the tire pressure is below a defined threshold.

The driving-stability-related system preferably remains deactivated if it was manually deactivated again after an automatic activation.

A driving-stability-related system may be an electronically controlled regulating system for longitudinal, lateral and/or vertical dynamics. Such systems are known, for example, as ESP (Electronic Stability Program) or DSC (Dynamic Stability Control). These systems optimize the driving stability, including the traction. They detect unstable driving conditions, such as understeering or oversteering, and help stabilize the vehicle by influencing the engine power and/or by braking interventions at individual wheels or at several wheels. Also systems, such as a DTC (Dynamic Traction Control), a DBC (Dynamic Brake Control), a dynamic drive, an AFS (Active Front Steering), a DXC (X-Drive, all-wheel control system), a dynamic drive (roll stabilization) or an air suspension, may also be driving-stability-related systems, as found, for example, in today's BMW vehicles. In these cases, for example, stabilizing braking interventions, drive interventions, steering interventions, and shock absorber adjusting interventions or level changes are carried out.

Some of these systems can be manually switched on and off by way of a switch or key. A switch may be a conventional electric hardware switch (or hardware key) as well as a software switch (or software key), as may be provided in today's computer-assisted function selection program having a control display; for example, known by the names i-Drive or MMI (such as a DSC or DTC software switch in the control display of a BMW i-Drive system).

By way of the invention, a manual switching-off of at least one of these driving-stability-related systems is, therefore, prohibited or ignored when a critical condition—particularly a loss of tire pressure—is determined.

Other objects, advantages and novel features of the present invention will become apparent from the following detailed description of the invention when considered in conjunction with the accompanying drawings.

### BRIEF DESCRIPTION OF THE DRAWING

The FIGURE is a block diagram of an embodiment of the present invention.

### DETAILED DESCRIPTION OF THE DRAWING

The single FIGURE illustrates an electronic control unit 1 which is used, for example, for the implementation of a DSC function and/or a DTC function. In addition to other input signals not shown here, the control device 1 receives the signal of a tire pressure control system 3 and of a DTC key 2 in the form of an electric hardware switch (or key), which is normally arranged in the center console of a vehicle.

The tire pressure control system 3 monitors the tire inflation pressure in the four mounted tires of a motor vehicle, which is not shown here, during the drive. For example, by way of a display, the tire pressure control system 3 indicates when, for example, the inflation pressure in one tire has clearly decreased in comparison to another tire and a loss of tire pressure is, therefore, determined. If the tire pressure control system 3 detects a loss of tire pressure in this or any other manner, the control unit 1 will receive that information.

The DSC function in the control unit 1 is always switched on and prevents a spinning or slipping of the driving wheels during the starting and accelerating operations. Furthermore, by way of the DSC function, unstable driving conditions are detected, such as a swerving of the vehicle's rear end or the lurching of the vehicle by way of the front wheels. In these cases, the DSC function helps to keep the vehicle on course by the reduction of the engine power and/or by braking interventions at individual wheels. The DSC function is always automatically activated after each engine start, but can also be manually deactivated by way of the DTC key 2 and activated again.

When the DTC key 2 is briefly operated once, the DSC function will be manually switched-off such that a switch-over takes place to the DTC function or only this DTC function remains activated. The DTC (Dynamic Traction Control) is a variant of the DSC and is optimized with respect to propulsion for special road conditions, for example, roadways from which snow has not been removed. The DTC function ensures a maximal propulsion, but with a limited driving stability. The DTC function is preferably automatically deactivated at an increased vehicle speed (approximately >70 km/h), or the increased DTC control thresholds are returned to the lower DSC control thresholds for the purpose of providing stability. This can take place abruptly, starting at a certain speed threshold or continuously over the speed.

When a loss of tire pressure is determined according to the invention, this is indicated to the control device 1 by the tire pressure control system 3. When the DSC function is switched off manually—that is, in the case of a switch-over to the DTC function—, the control device 1 then automatically activates the (complete) DSC function again.

A deactivation of a system is, therefore, also a limitation of the system or a switch-over to a different function mode of the system, as in the preceding case.

In addition, for example, the DTC function, as well as the DSC function, can be switched off by a prolonged operation of the DTC key 2. The control device 1 will then also automatically activate at least the DTC function, but preferably also the (complete) DSC function if both functions had previously been switched-off manually.

If one of the functions is then manually deactivated again because it is intentionally desired by the driver, in a further development of the invention, this function continues to be deactivated at least for the current ignition cycle even if a loss of tire pressure was determined.

The forced activation of the DCS and/or the DTC may be indicated to the driver by way of suitable indicating devices in the instrument panel (such as lamps, symbols, text information).

In a supplementary manner, in the event of a loss of tire pressure—in order to avoid an inclined position of the vehicle and, as a result, not unnecessarily impair the longitudinal and lateral stability—the vehicle body can also be raised by way of the air suspension at the concerned impaired wheel.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of stabilizing a vehicle in an event of a loss of tire pressure, the method comprising the acts of:
determining an activation state of a driving-stability-related system, which system is manually deactivatable; and
automatically activating the driving-stability-related system that is in a manually deactivated state upon determining a loss of tire pressure or a tire pressure below a defined threshold.

2. The method according to claim 1, wherein the driving-stability-related system remains deactivated following a manual deactivation again after the automatically activating act.

3. A system for stabilizing a vehicle in an event of a loss of tire pressure, the system comprising:
a driving-stability-related system;
a tire pressure sensing system; and
a control system receiving inputs from the tire pressure sensing system and the driving-stability-related system, wherein the control system operates to automatically activate the driving-stability-related system upon sensing a loss of tire pressure or a tire pressure below a defined threshold when the driving-stability-related system is in a manually deactivated state.
